(19) United States
(12) Patent Application Publication
(10) Pub. No.: US 2012/0239434 A1
(43) Pub. Date: Sep. 20, 2012

(54) SYSTEM AND METHOD FOR GENERATING GRAPHICAL REPRESENTATION OF PATIENT STATUS

(75) Inventors: Michael Joseph Breslow, Lutherville, MD (US); Mark Lindell, Cockeysville, MD (US)

(73) Assignee: KONINKLIJKE PHILIPS ELECTRONICS N.V., EINDHOVEN (NL)

(21) Appl. No.: 13/509,807

(22) PCT Filed: Dec. 13, 2010
(86) PCT No.: PCT/IB10/55782

§ 371 Date: May 15, 2012

Related U.S. Application Data
(60) Provisional application No. 61/285,576, filed on Dec. 11, 2009.

(51) Int. Cl. G06Q 50/24

(52) U.S. Cl. 705/3

(57) ABSTRACT

A graphical representation of patient status. A smart graphic is created by a smart graphic generator from data associated with a patient. The smart graphic may represent a state of various physiological systems at a point in time and provide other patient data of interest to a healthcare provider in graphical form. The smart graphic may be continuously updated with the most current patient state information. The smart graphic may also permit the healthcare provider immediate interactive access to the data underlying the graphical representations and data related thereto.

### BACKGROUND

Healthcare is increasingly computer-based. Patient data is routinely collected and assessed by computing devices and the results made available to healthcare providers in a variety of forms. For example, an electronic system may present near-real-time indications of physiological parameters, lab results and patient evaluations to a healthcare provider via a visual display. Alarming systems may alert a healthcare provider of a change in the patient's condition based on one or more factors.

The ability of electronic systems to capture patient data often exceeds the ability of healthcare providers to process those data in a meaningful way. To alleviate the potential for data overload, the visual display of patient data may be augmented with symbolic representations of the patient's current state. For example, alarming systems may alert a healthcare provider to a change in a patient's condition based on one or more factors. Audio and visual cues may be used to indicate the nature of the change in the patient's condition (improvement, degradation) and the severity of the change. Data may also be expressed using iconic representations of the patient so that patient data may be related to particular physical systems and/or functions.

### SUMMARY

While iconic and graphical representations of a patient's condition are helpful, they only provide a simplified view of a patient's condition. To fully realize the potential of electronic patient monitoring systems, a graphical representation of the state of a patient should be continuously updated (dynamic) and should provide a healthcare provider access to the underlying patient data in a logical and intuitive way to allow the healthcare provider to make decisions regarding the patient's treatment (interactive).

Embodiments herein are directed to systems and methods for providing an interactive and dynamically updated “smart” graphical representation of measures indicative of a patient's current state and predictive of a patient's future state.

In an embodiment, a smart graphic is created by a smart graphic generator from data associated with a patient. The smart graphic may represent a state of various physiological systems at a point in time and provide other patient data of interest to a healthcare provider in graphical form. The smart graphic may be continuously updated with the most current patient state information. The smart graphic may also permit the healthcare provider immediate interactive access to the data underlying the graphical representations and data related thereto.

### DESCRIPTION OF THE DRAWINGS

FIG. 1 is a block diagram illustrating the components of a patient care system according to embodiments.

FIG. 2 is a block diagram illustrating a smart graphic according to an embodiment.

FIG. 3 is a block diagram illustrating components of a smart graphic generator according to an embodiment.

FIG. 4 is a component block diagram illustrating a computing device suitable for use in the various embodiments.

FIG. 5 is a component block diagram illustrating a server device suitable for use in the various embodiments.

FIG. 6 is a component block diagram illustrating a lap top device suitable for use in the various embodiments.

FIG. 7 is a component block diagram illustrating a computer suitable for use in the various embodiments.

### DETAILED DESCRIPTION

In the description that follows, the term “patient” may include a critically ill patient, an acutely ill patient, a patient with a specific chronic illness(es), a patient with serious injuries, a patient with an uncertain diagnosis, and a patient recovering from surgery, obstetric patients, well patients and/or other procedure.

In the description that follows, the term “patient data” encompasses data that is acquired from the patient or others verbally, by observation of the patient or others related to the patient, from analysis of samples taken from the patient, from an assessment of the patient, from a treatment or procedure performed on the patient, and from samples taken by others related to the patient. By way of illustration and not by way of limitation, patient data may include data relating to a patient's diagnosis, prescriptions, history, condition, laboratory results and other health-relevant data.

In the description that follows, the term “monitored patient data” encompasses data that is acquired in near-real-time and non-real-time physiological data from a patient by a monitoring device connected to the patient as well as patient location data which may comprise GPS data.

In the description that follows, the term “patient state data” encompasses all data relating to a patient including patient data and monitored patient data.

In the description that follows, the term “data element” encompasses a unit of data that may be used to assess a patient's state.

In the description that follows, the term “computing device” encompasses, for example, desktop computers, laptop computers and mobile devices and other processor-equipped devices that may be developed in the future that may be configured to permit a user to interact other devices over a network. As used herein, a “mobile device” encompasses cellular telephones, personal data assistants (PDA), and smart telephones.

In the description that follows, a “server” is a computing device that may be configured to interact in an automated fashion with other devices over a network to serve content, web pages, and information.

In an embodiment, a smart graphic is created by a smart graphic generator from data associated with a patient. The smart graphic may represent a state of various physiological systems at a point in time and provide other patient data of interest to a healthcare provider in graphical form. In addition, the smart graphic displays how far or close a patient's actual pain score, sedation score, or delirium score is from the goal score that is set for that particular patient (the display would show how much above or below a patient is from a desired level). In addition to physiologic response to therapy, the smart graphic will display when a particular patient therapy is being decreased (for example when a patient is improving). Thus if a patient is on a stable dose of a drug at a desired goal, the smart graphic will so indicate. However, an embodiment of the smart graphic will also alert the clinician when the dose needs to begin to be decreased as well. In this example, the longer the dose remains the same, the higher a score will be, which will in turn bring the situation to the attention of the clinician. The smart graphic may be continuously updated with the most current patient state information. The smart graphic may also permit the healthcare provider immediate interactive access to the data underlying the graphical representations and data related thereto by simply “clicking” on the portion of the smart graphic displaying the patient information of interest. In so doing, a request is sent to the system to provide a display of the underlying data to the users display system. Scores will also increase or decrease depending on the individual patient state. For example, if a patient is particularly at risk, the patient's score will generally be higher and thus more sensitive to actuation of alarms that might be set.

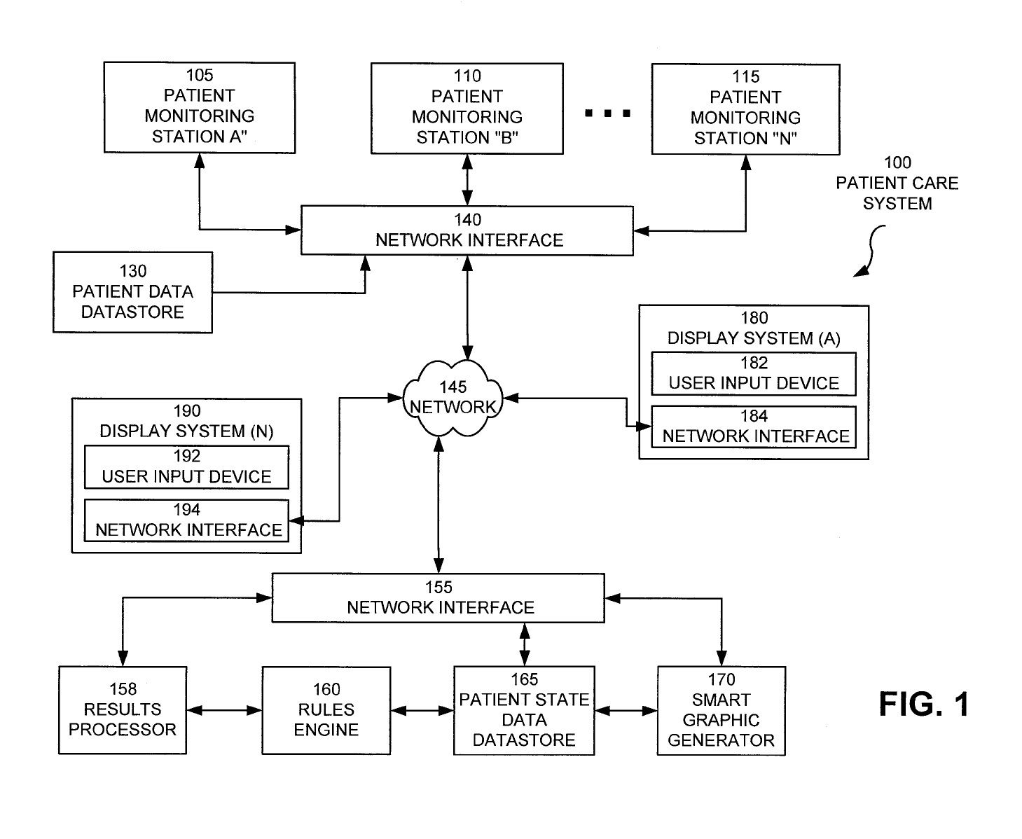

FIG. 1 is a block diagram illustrating the components of a patient care system according to embodiments. A patient care system 100 comprises a plurality of patient monitoring stations, including, for example a patient monitoring station “A” 105, a patient monitoring station “B” 110, and a patient monitoring station “N” 115. The patient monitoring stations 105, 110, and 115 connect to a network 145 via a network interface 140. The network 145 may be a wired network, a wireless network, a satellite network, a public switched telephone network, an IP network, a packet switched network, a cell phone network, a cable network, a coax network, and a hybrid fiber coax network.

The patient monitoring stations 105, 110, and 115 may be used from a single location or from different locations.

While a single network interface 140 is illustrated, this is not meant as a limitation. The patient monitoring stations may share a network interface or access the network 145 through some other network interface (not illustrated).

The patient monitoring stations “A” 105, “B” 110, and “N” 115 monitor physiological data, audio data and video data from “N” patients. Each patient is associated with a specific patient monitoring station. For the sake of clarity, the description that follows may refer to the patient monitoring station “A” 105 when describing certain features and/or functions performed by the patient monitoring systems generally. However, the description applies to all patient monitoring stations within the patient care system 100.

In an embodiment, the patient monitoring station A 105 may acquire physiological data, audio data, and video data from a patient in real-time. The network interface 140 provides access to the network 145 for transmission of the monitored physiological data, video signal, and audio signals to a patient state data datastore 165. Also connected to the network 145 is a patient data datastore 130. As illustrated, the patient datastore 130 is connected to the network 145 via the network interface 155. However, this is not meant as a limitation. Based on the location of the patient datastore 130, the connection to the network 145 may be made via some other network interface (not illustrated).

The patient state data datastore 165 receives the monitoring data from the patient monitoring stations 105, 110, and 115 and also receives the patient data from the patient data datastore 130. By way of illustration and not as limitation, the patient state data datastore may include data relating to personal information about the patient (name, address, marital status, age, gender, ethnicity, next of kin), medical history (illnesses, injuries, surgeries, allergies, medications), hospital and/or outpatient information (symptoms, physiological data, time of admission, observations of admitting caregiver), treatment, lab data, test reports (radiology reports and microbiology reports for example), physician's notes, a patient's diagnosis, prescriptions, history, condition, laboratory results and other health-relevant data.

In an embodiment, the patient data may also be received from sources (not illustrated) other than the patient data datastore 130, including by way of example, doctors offices, laboratories, pharmacies, and healthcare facilities.

While the patient state data datastore 165 and patient data datastore 130 are illustrated as discrete elements, this is not meant to be limiting. The patient state data datastore 165 and patient data datastore 130 may be distributed among various storage devices accessible to the network 145.

Also connected to the patient state data datastore 165 are a rules engine 160 and a smart graphic generator 170.

The rules engine 160 applies rules to data elements stored in the patient state datastore 165 associated with a specific patient to identify medical conditions and changes in the state of the patient. In an embodiment, the rules engine may apply rules repeatedly and automatically 24 hours per day 7 days per week to data elements of the plurality of patients. This is not meant to imply that any given patient rule is exercised with every clock cycle of the computer that runs the rules engine. Rather, the rules engine is constantly alert for the receipt of data into the patient datastore. When data comes in, it is tagged with information concerning a particular patient. For example, when a laboratory result arrives in the patient datastore for Patent A, the rules engine notes the arrival of that data, and determines if that laboratory result is required for a particular rule about Patient A. If not, no action is taken by the rules engine and the smart graphic generator updates the smart graphic of patent A that can be accessed. If however, the data IS required for a rule associated with Patient A, the rules engine will use that data in the rule for patient A to determine if an alarm condition exists. If an alarm condition exists, the rules engine notes that situation in the Patient State Datastore and the smart graphic generator will update the smart graphic for Patient A and send it over the network interface on a priority basis to be immediately displayed and/pr transmitted to caregivers associated with Patient A, In this example, the smart graphic would be displayed with a visually active (for example and without limitation a flashing section of the smart graphic) to alert the caregiver to a rule-based alarm for the specific data being displayed in the smart graphic.

A results processor 158 uses information generated by the rules engine 160 to determine if an alert should be issued or to determine if an assessment measure relating to the state of the patient should be updated. The results processor 165 is accessible over the network 145 via the network interface 155.

The smart graphic generator 170 also has access to the data stored in the patient state data datastore 165. In addition, the smart graphic generator 170 has access to the results processor 158 via the network 145. The smart graphic generator 170 utilizes these data to generate a smart graphic (described below) that is accessible via the network 145 for display on one or more display systems, such as display system (A) 180 and display system (N) 190 (sometimes referred to herein as a “caregiver display system”).

Display system (A) 180 comprises a user input device 182 and a network interface device 184. Display system (N) 190 comprises a user input device 192 and a network interface device 194. In an embodiment the caregiver display systems may be at a central command center that is constantly manned by intensivists. In another embodiment, the display system could be a portable device such as a smart phone, a tablet computer, a notebook computer or laptop computer, and/or a desktop computer at another caregiver's office such as a doctor or other location of personnel who are monitoring patients remotely.

The caregiver display will typically comprise network interfaces and some form of user input means such as, and without limitation, a keyboard, a mouse, a trackball, voice commands, and touch screens. Other input means available in the future will also find use in interacting with the smart graphic.

The locations of the components illustrated in FIG. 1 are not critical to the operation of the system. For example, the patient state data datastore 165, the rules engine 160 and the smart graphic generator 170 may be co-located or distributed over a number of locations that are accessible via the network 145.

The locations of display systems (A) 180 and (N) 190 is only conditioned on access to the network 145. For example, a display system may located in at the healthcare facility where the patients are located, collocated with some or all of the patient state data datastore 165, the rules engine 160 and the smart graphic generator 170, or located in a healthcare facility geographically remote from the patient location and the location of the of the patient state data datastore 165, the rules engine 160 and the smart graphic generator 170.

In an embodiment, the patient monitoring functions, the patient state data evaluation functions and the patient care functions may be performed by different entities. The functions may be packaged as distinct services that are provided for a fee.

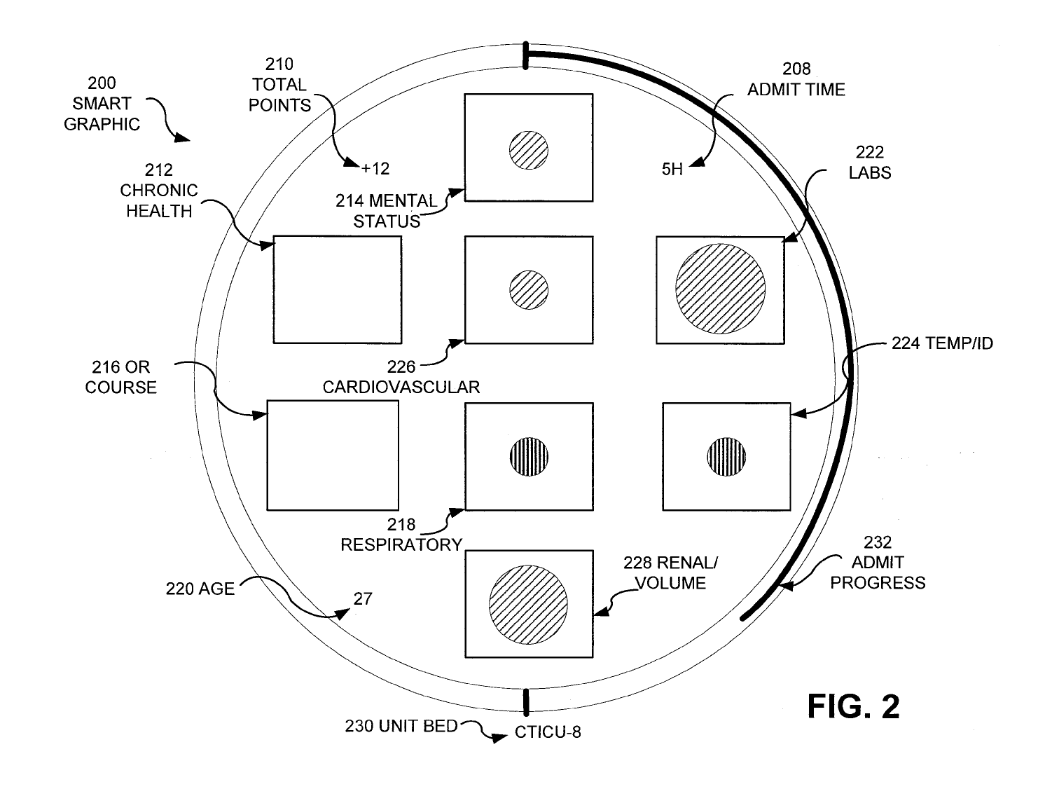

FIG. 2 is block diagram illustrating the elements of a smart graphic according to an embodiment.

As illustrated in FIG. 2, the smart graphic 200 has a circular shape. However, this is not meant as a limitation. The shape of the smart graphic 200 may be any convenient shape. Further, the smart graphic may be two dimensional or three-dimensional in appearance depending on the amount and complexity of the data to be displayed.

The smart graphic 200 comprises a graphical shape comprising a plurality of regions (for example, regions 208, 210, 212, 214, 216, 218, 220, 222, 224, 226, 228, 230, and 232). The number of regions and the location of a region relative to another region is a design choice. In an embodiment, the layout of smart graphic 200 is user definable.

The regions of smart graphic 200 may be assigned to physiological systems comprising measures indicative of a patient's current state and to other data fields that may be useful in identifying the patient and assessing the treatment of the patient. For illustrative purposes, the regions of the smart graphic 200 have been assigned the following measures:

TABLE 1

| REGION | MEASURE |
|---|---|
| 208 | Admit Time |
| 210 | Total Points |
| 212 | Chronic Health |
| 214 | Mental Status |
| 216 | OR Course |
| 218 | Respiratory |
| 220 | Age |
| 222 | Labs |
| 224 | Temperature/ID |
| 226 | Cardiovascular |
| 228 | Renal/Volume |
| 230 | Unit Bed |
| 232 | Admit Progress |

As illustrated, the regions that represent measured or assessed parameters (for example, regions 212-218 and 222-228) comprise an indicator of a level of departure of a parameter value from a desired value and measure of the significance of any departure. As illustrated in FIG. 2, the indicator may reflect the level of departure and the significance of the departure through the use of various attributes including, for example, size, color, hue, and animation. For example, the indicator size may be reflective of the magnitude of the departure of the parameter from a desired value and a color may be reflective of the medical significance of the departure.

For a measured or assessed parameter, points may be assigned to the parameter based upon the level of departure of a parameter from a desired value and its significance. In an embodiment, the indicator size may reflect the number of points assigned to a particular parameter based on the magnitude of the departure of the parameter value from a desired value, and the color of the indicator may reflect the number of points assigned to the particular parameter based on the medical significance of the departure. The description above is exemplary in nature. Other graphics that illustrate other conditions may also be used and are considered within the scope of the embodiments described herein.

As illustrated in FIG. 2, at the time the smart graphic was generated, the Labs indicator in region 222 and the Renal/Volume indicator in region 228 are indicative of values that may be of concern to a healthcare provider.

The determination of the significance of a departure from a desired value may be performed by the smart graphic generator 170 in accordance with software instructions that weigh the measured values in light of other patient state data elements. For example, the significance of a departure from a desired value may depend on the patient's diagnosis, age, history, family history, time at the healthcare location, among other data elements.

As illustrated, the region 208 is assigned to the admit time of the patient. The admit time provides a healthcare provider a numerical indication of the how long the patient has been admitted to the health care facility providing treatment. The region 232 is assigned to the admit progress, which provides a graphical indicator of the elapsed since the patient was admitted.

As illustrated, the region 210 is assigned to a total points measure. In an embodiment, the results from the results processor 158 are combined by the smart graphic generator 170 with other patient state data elements to provide a quantified measure of a patient's current state using a point system. In an embodiment, the points measure assigned to region 210 is a composite “score” based on the points assigned to each of the parameters of the other regions of the smart graphic 200. For example, using the illustrative measures assigned to regions 212-218 and 222-228, the total points measure is set to +12 by the graphic generator 170.

The smart graphic 200 reflects the state of a patient at a point in time. The smart graphic 200 is dynamically generated from the data elements acquired by the patient state data datastore 165. As previously noted, the patient care system 100 may “continuously” monitor the condition of a plurality of patients in accordance with the requirements of the rules established for the patients under the care of the patient care system 100. “Continuously” is this context means that patient care system 100 is in a ready state to receive data from monitored patients and to apply patient-specific rules in accordance with the requirement of those rules. An individual rule may, for example, require that data for that particular patient be evaluated on a scheduled basis, each time new data arrives, or based on a condition that depends on previous assessments of the patient state data. Thus, the patient care system 100 may be characterized as operating continuously even though the system may not be processing data for any particular patient at a particular moment in time. Similarly, the smart graphics generator 170 may also be characterized as operating “continuously” or “dynamically” to reflect the most current patient state data.

In an embodiment, the regions of the smart graphic 200 may be populated with links. The links allow a healthcare provider to interact with the patient care system 100 by selecting a link so as to obtain patient state data relating to a measure associated with a particular region. The link may provide additional links so as to permit the healthcare provider to intelligently navigate to the desired information. For example, a link may provide the healthcare provider access to the patient state data used to determine the points assigned to the measure associated with a particular region while another link may allow the healthcare provider to navigate to a detailed explanation of the computation used to arrive at the particular departure score and/or significance score assigned to the particular measure. Further, the graphic region of interest may be magnified thereby reveal increasingly more precise and different types of data that contributed to the representation of the graphic as first viewed by the care giver. In addition to the graphic representation of a variety of patent data and conditions, the graphic itself can be “active” meaning, for example, a flashing display of a particular region of the graphic when a rule for the patient requires and alarm to be displayed.

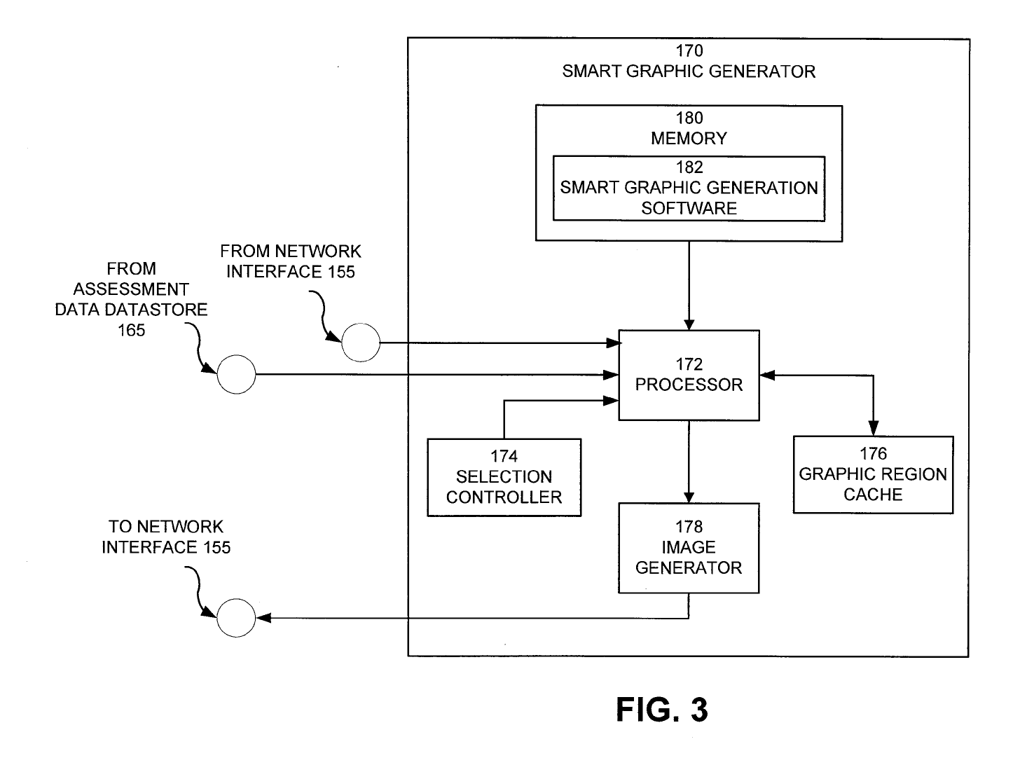

FIG. 3 is a block diagram illustrating components of a smart graphic generator according to an embodiment.

In an embodiment, a smart graphic generator comprises a processor 172. The processor 172 executes smart graphic generation software 182 stored in a memory 180 that may be accessed by the processor 172. In an embodiment, the smart graphic generation software 182 may be loaded and/or updated over network 145 via network interface 155.

The smart graphic generation software 182 comprises instructions that allow the processor 172 to perform operations on elements of the patient state data stored in patient state data datastore 165 and the results provided by the results processor 158 based on the of the operation of the rules engine 160. For example, the software instructions may allow the processor 172 to determine the attributes of an indicator for each measure associated with a region of smart graphic 200. As previously described, the attributes of a measure may be selected to reflect a level of departure of a parameter value from a desired value and to reflect a measure of the medical significance of any such departure. As illustrated in FIG. 2, the indicator may reflect the level of departure and the significance of the departure through the use of various attributes including, for example, size, color, hue, and animation. For example, the indicator size may be reflective of the number of the departure of the parameter from desired value and a color may be reflective of the medical significance of the departure.

The smart graphic generation software 182 may further comprise instructions to allow the processor 172 to assign points to a measured or assessed parameter based upon the level of departure of a parameter from a desired value and its significance. In this embodiment, the smart graphic generation software 182 applies weighting algorithms to the data elements acquired from the patient state data datastore 165 and the results processor 158 to determine the significance of a departure. The weights assigned to a particular data element or group of data elements by the smart graphic generation software 182 may depend on a “context” of the patient's situation. For example, the significance of a departure from a desired value may depend on the patient's diagnosis, age, history, family history, time at the healthcare location, among other data elements.

The output of the processor 172 is received by an image generator 178. The image generator produces a smart graphic 200 that is accessible via the network 145 for display by a display system, such as, for example display systems (A) 180 and (N) 190. As used herein the term “accessible” is not meant to be passive only. In an embodiment, the smart graphic is “pushed” to those who need to see the smart graphic in the event of some alarm condition. In such an instance, those who are listed as requiring information concerning patient will be automatically sent the smart graphic comprising the alarm state. Unlike a conventional pager system however, the caregiver has access to all information depicted in the smart graphic, can actuate the links in the smart graphic to review the underlying patent data that is described in any specific portion of the smart graphic. Using the power of the current and future generations of smart phone, the smart graphic can be magnified and interacted with by the care giver regardless of the location of that care giver. The smart graphic will also be delivered with embedded permissions such that a caregiver may be able to view patent data appropriate to the level of the care giver. For example, a nurse may be able to view the smart graphic but would not be able to generate orders for patient treatment. Conversely a treating physician will have such permissions and the generation of orders would be permitted with such an option available graphically to the doctor.

In an embodiment, the smart graphic generator 170 further comprises a selection controller 174 and a graphic region cache 176. The selection controller is responsive to user input signals generated by the user input device component (element 182 of display system (A) 180 and element 192 of the display system (N) 190). The selection controller 174 maps a user input signal to the selection of a particular link. The selection of a link provides the user access to data and information retained in a graphic region cache 176. The graphic region cache 176 comprises the data elements and information used to select the attributes associated with the measures assigned to each of the regions of the smart graphic 200.

In an embodiment, the graphic region cache 176 is overwritten when an updated smart graphic 200 is generated. In an embodiment, when the graphic region cache is being viewed by a user, the overwriting of the cache is suspended. Any updated data is written to a temporary location and only written to the cache when the user returns to the viewing the smart graphic 200.

In another embodiment, a number of display systems such as, for example, display systems (A) 180 and (N) 190, may access the smart graphic 200 simultaneously. In this embodiment, it is anticipated that any number of uses may interact with the links associated with the various regions of the smart graphic 200. In this embodiment, when a user accesses a link associated with a region, the graphic region cache establishes a session for the user and the graphic region cache 176 for that instance of the smart graphic 200. Each user thus has an independent but real-time view of the smart graphic 200. A particular user's view of the smart graphic 200, is unaffected by the interaction of another view with the smart graphic 200. In addition, when a user interacts with the smart graphic 200, the state of the smart graphic may be stored in memory and maintained during the interactive session unaffected by changes in the underlying data that was used to generate the specific instance of the smart graphic 200. In this way, one user may view a current instance of the smart graphic 200 while another user is navigating the data used to generate a previous instance of the smart graphic 200. In an embodiment, the user that is navigating the previous instance of the smart graphic 200 may be advised that the data have been updated and given the opportunity to view the updated instance of the smart graphic 200.

In an embodiment, the physiological systems assigned to the regions of the smart graphic 200 may vary over time. In this embodiment, the circular depiction of the smart graphic 200 may be visualized as a sphere that rotates periodically to reveal additional regions and additional patient information. In an embodiment, a region assigned to a physiological system having a parameter value that significantly departs from a desired value remains in view despite the apparent rotation of the smart graphic sphere.

The smart graphic is not limited to a circle or spherical shape. The figures herein are exemplary in nature only. Further, nothing herein is meant to limit the smart graphic to a particular healthcare situation. For example, the smart graphic may be used remotely from the patient in, for example and without limitation, a command center that is manned consistently on a 24/7 basis by healthcare professionals, thereby guaranteeing that the smart graphic associated with any particular patient (or group of patients) accessible at all times that a patient is receiving treatment or being monitored. Additionally, upon the triggering of a rule for any particular patient, and as noted above, the smart graphic may be pushed to the care giver and displayed on a priority basis so that action may be taken with enhanced priority based on the data being displayed.

In addition to the display of the current smart graphic for any given patient, in an embodiment, the smart graphic may be generated in an ad hoc manner to show the state of a patient at any desired point in time in the past. Thus a caregiver can compare the smart graphic at time A with the current smart graphic for patient. Alternatively, the smart graphic for time A can be compared with the smart graphic for time B, also in the past. Further, the smart graphic generator can create a progression of smart graphics for a caregiver so that the care giver can review the progress of a patient of over time by reviewing a series for ever changing smart graphics over time that are associated with any particular patient. Further, the patent data store can be used for analysis purposes relating to populations of patients by displaying smart graphics that comprise average or other general smart graphics for populations of similarly situated patients.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Further, words such as “thereafter,” “then,” “next,” etc. are not intended to limit the order of the steps; these words are simply used to guide the reader through the description of the methods.

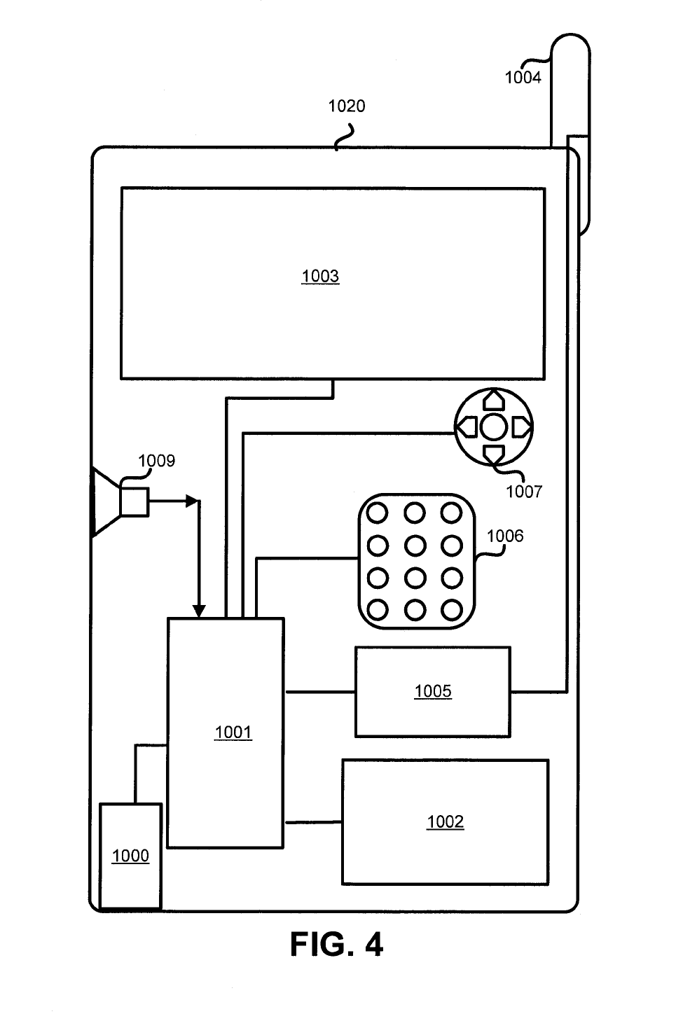

Typical computing devices suitable for use with the various embodiments will have in common the components illustrated in FIG. 4. For example, the exemplary computing device 1020 may include a processor 1001 coupled to internal memory 1002, a display 1003 and to a SIM 1009 or similar removable memory unit. Additionally, the computing device 1020 may have an antenna 1004 for sending and receiving electromagnetic radiation that is connected to a wireless data link and/or cellular telephone transceiver 1005 coupled to the processor 1001. In some implementations, the transceiver 1005 and portions of the processor 1001 and memory 1002 used for cellular telephone communications are collectively referred to as the air interface since it provides a data interface via a wireless data link. Computing devices typically also include a key pad 1006 or miniature keyboard and menu selection buttons or rocker switches 1007 for receiving user inputs. Computing device 1020 may also include a GPS navigation device 1000 coupled to the processor used for determining the location coordinates of the computing device 1020.

The processor 1001 may be any programmable microprocessor, microcomputer or multiple processor chip or chips that can be configured by software instructions (applications) to perform a variety of functions, including the functions of the various embodiments described herein. In some computing devices, multiple processors 1001 may be provided, such as one processor dedicated to wireless communication functions and one processor dedicated to running other applications. Typically, software applications may be stored in the internal memory 1002 before they are accessed and loaded into the processor 1001. In some computing devices, the processor 1001 may include internal memory sufficient to store the application software instructions. The internal memory of the processor may include a secure memory 1008 which is not directly accessible by users or applications and that is capable of recording MDINs and SIM IDs as described in the various embodiments. As part of the processor, such a secure memory 1008 may not be replaced or accessed without damaging or replacing the processor. In some computing devices, additional memory chips (e.g., a Secure Data (SD) card) may be plugged into the device 1020 and coupled to the processor 1001. In many computing devices, the internal memory 1002 may be a volatile or nonvolatile memory, such as flash memory, or a mixture of both. For the purposes of this description, a general reference to memory refers to all memory accessible by the processor 1001, including internal memory 1002, removable memory plugged into the computing device, and memory within the processor 1001 itself, including the secure memory 1008.

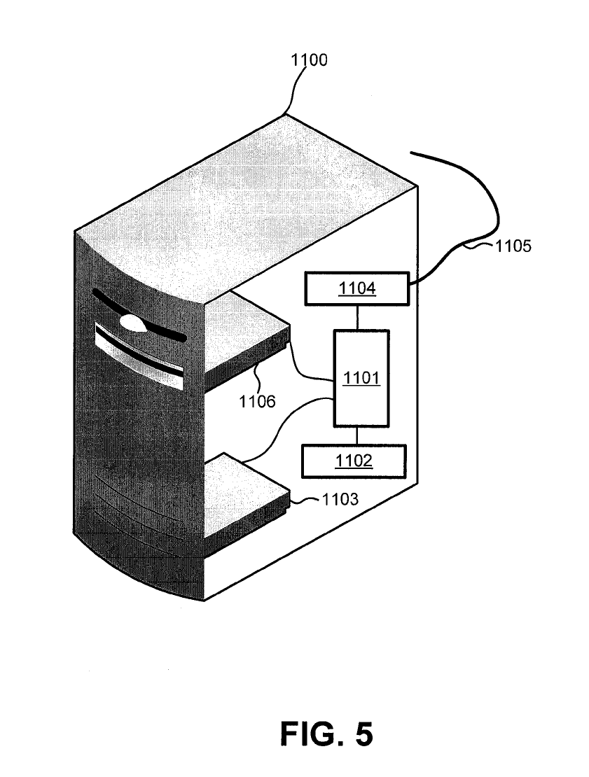

A number of the embodiments described above may also be implemented with any of a variety of remote server devices, such as the server 1100 illustrated in FIG. 5. Such a server 1100 typically includes a processor 1101 coupled to volatile memory 1102 and a large capacity nonvolatile memory, such as a disk drive 1103. The server 1100 may also include a floppy disc drive and/or a compact disc (CD) drive 1106 coupled to the processor 1101. The server 1100 may also include network access ports 1104 coupled to the processor 1101 for establishing data connections with network circuits 1105, such as the Internet.

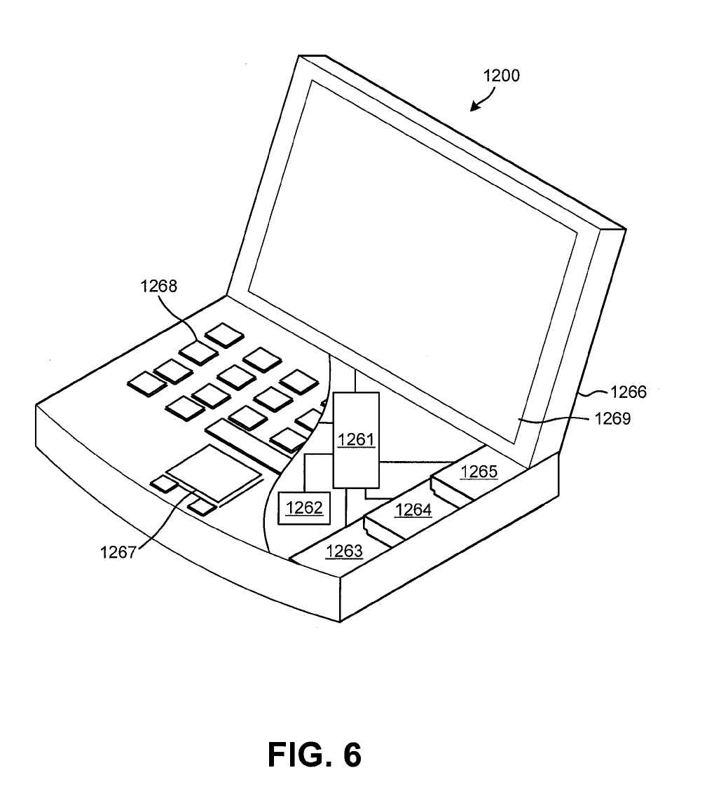

A number of the aspects described above may also be implemented with any of a variety of computing devices, such as a notebook computer 1200 illustrated in FIG. 6. Such a notebook computer 1200 typically includes a housing 1266 that contains a processor 1261 coupled to volatile memory 1262 and a large capacity nonvolatile memory, such as a disk drive 1263. The computer 1200 may also include a floppy disc drive 1264 and a compact disc (CD) drive 1265 coupled to the processor 1261. The computer housing 1266 typically also includes a touchpad 1267, keyboard 1268 and the display 1269.

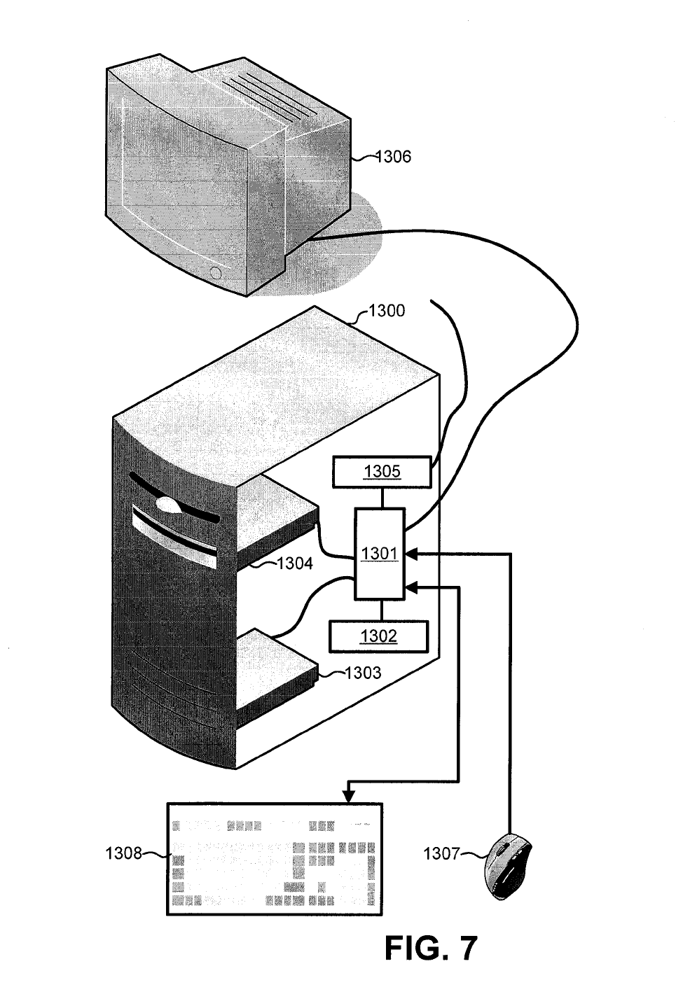

The embodiments described above may also be implemented on any of a variety of computers, such as a personal computer 1300 illustrated in FIG. 7. Such a personal computer 1300 typically includes a processor 1301 coupled to volatile memory 1302 and a large capacity nonvolatile memory, such as a disk drive 1303. The computer 1300 may also include a floppy disc drive 1304 and a compact disc (CD) drive 1305 coupled to the processor 1301. Typically the computer 1300 will also include a pointing device such as a mouse 1307, a user input device such as a keyboard 1308 and a display 1308. The computer 1300 may also include a number of network connection circuits 1306, such as a USB or FireWire®, coupled to the processor 1301 for establishing data connections to external devices such as a programmable device being tested. In a notebook configuration, the computer housing includes the pointing device 1307, keyboard 1308 and the display 1309 as is well known in the computer arts.

The foregoing method descriptions and the process flow diagrams are provided merely as illustrative examples and are not intended to require or imply that the blocks of the various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The blocks of a method or algorithm disclosed herein may be embodied in a processor-executable software module executed which may reside on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the scope of the invention. Thus, the present invention is not intended to be limited to the embodiments shown herein but is to be accorded the widest scope consistent with the following claims and the principles and novel features disclosed herein.

1. A system for generating a graphical representation of patient status comprising:
a network
a patient state data (PSD) datastore accessible via the network, wherein the PSD datastore comprises patient state data;
a rules engine having access to the network, wherein the rules engine applies rules to data elements stored in the PSD datastore;
a results processor connected to the rules engine and having access to the network, wherein the results processor is configured with software instructions to cause the results processor to perform operations comprising:
receiving the output of the rules engine;
determining from the output of the rules engine whether an assessment measure relating to the state of the patient should be updated;
a smart graphic generator connected to the PSD datastore, wherein the results processor is configured with software instructions to cause the smart graphic generator to perform operations comprising:
receiving the determinations from the results processor;
receiving the data elements stored in the PSD datastore;
generating a smart graphic, wherein the smart graphic comprises regions associated with measures determined from the data elements stored in the PSD datastore and the determinations of the result processor and wherein the smart graphic is accessible to a display system via the network.

2. The system of claim 1, wherein the rules engine applies rules repeatedly and automatically 24 hours per day 7 days per week.

3. The system of claim 1 wherein, upon the determination by the rules engine of a rule condition requiring notification of a caregiver, the smart graphic generator generates a smart graphic that is sent to a caregiver display system.

4. The system of claim 3 wherein the caregiver display system is taken from the group consisting of a smartphone, a laptop, a tablet computer, and desktop display.

5. The system of claim 1 wherein the smart graphic generator comprises instructions for generating a smart graphic comprising a plurality of user definable regions, each region representing a patient data element indicative of a patient's current state.

6. The system of claim 5 wherein the patient's current state comprises at least one data element taken from the group consisting of name, admit time, laboratory data, temperature, admit progress, bed location, renal volume respiratory data, cardiovascular data mental status, chronic health data, operating room course, age, and point score.

7. The system of claim 5 wherein the smart graphic generator comprises instructions for generating regions of the smart graphic comprising at least one characteristic taken from the group consisting of size, two dimensional shape, three dimensional shape, color, grading, and visual activity.

8. The system of claim 5 wherein the smart graphic generator comprises instructions for linking the regions to underlying PSD associated with the regions and for receiving requests via a user input means at a selection controller for displaying the underlying PSD from a region cache.

9. The system of claim 8 wherein the region cache comprises the data elements and information associated with the measures assigned to each of the regions of the smart graphic.

10. The system of claim 8 wherein the user input means are taken from the group consisting of a keyboard, a mouse, a trackball, voice commands and a touch screen.

11. The system of claim 1 wherein the smart graphic generator comprises:
a processor for executing smart graphic generation software stored in a memory;
a selection controller responsive to user input means; and
a graphic region cache comprising data elements and information used to select the attributes associated with the measures assigned to each of the regions of the smart graphic.

12. A method for generating graphical representations of patient status comprising:
storing patient state data (PSD) in a PSD datastore connected to a network;
applying rules to data elements stored in the PSD datastore via a rules engine connected to the network;
receiving the output of the rules engine at a results processor;
determining from the output of the rules engine whether an assessment measure relating to the state of the patient should be updated;
receiving the determinations from the results processor at a smart graphic generator;
retrieving data elements stored in the PSD datastore;
generating a smart graphic based on the retrieved data elements, wherein the smart graphic comprises regions associated with measures determined from the data elements stored in the PSD datastore; and
displaying the smart graphic over the network.

13. The method of claim 12 further comprising applying the rules repeatedly and automatically 24 hours per day 7 days per week.

14. The method of claim 13 further comprising determining via the rules engine, that a rule condition requires notifying a caregiver of the rule condition;
generating a smart graphic of the PSD; and
sending the smart graphic to a caregiver display system.

15. The method of claim 14 wherein the caregiver display system is taken from the group consisting of a smartphone, a laptop, a tablet computer, and desktop display.

16. The method of claim 14 wherein generating a smart graphic comprises generating a graphic comprising a plurality of user definable regions, each region representing a patient data element indicative of a patient's current state.

17. The method of claim 16 wherein the patient's current state comprises at least one data element taken from the group consisting of name, admit time, laboratory data, temperature, admit progress, bed location, renal volume respiratory data, cardiovascular data mental status, chronic health data, operating room course, age, and point score.

18. The method of claim 16 generating the smart graphic comprises generating regions of the smart graphic comprising at least one characteristic taken from the group consisting of size, two dimensional shape, three dimensional shape color, grading, and visual activity.

19. The method of claim 16 further comprising linking the regions to underlying PSD associated with the regions and receiving requests via a user input means at a selection controller for displaying the underlying PSD from a region cache.

20. The method of claim 19 wherein the region cache comprises the data elements and information associated with the measures assigned to each of the regions of the smart graphic.

21. The method of claim 19 wherein the user input means are taken from the group consisting of a mouse, a trackball, voice commands and a touch screen.

22. The method of claim 19 further comprising creating a smart graphic series relating to the PSD of a particular patient at over a period of time; and
displaying the smart graphic series on the caregiver display system.

23. The method of claim 19 further comprising creating a smart graphic representing a patient population.
